(19) United States
(12) Patent Application Publication
(10) Pub. No.: US 2016/0023910 A1
(43) Pub. Date: Jan. 28, 2016

(54) APPARATUS AND METHOD OF MAKING ALKALI ACTIVATED CARBON

(71) Applicant: CORNING INCORPORATED, CORNING, NY (US)

(72) Inventors: Kirk Richard Colvin, Corning, NY (US); David Anthony Hirtler, Horseheads, NY (US); Atul Kumar, Horseheads, NY (US); Samuel Odei Owusu, Horseheads, NY (US); Kamjula Pattabhirami Reddy, Corning, NY (US); Rebecca Lynn Schulz, Horseheads, NY (US)

(21) Appl. No.: 14/338,898

(22) Filed: Jul. 23, 2014

(51) Int. Cl. C01B 31/12; B01J 19/18

(52) U.S. Cl. CPC C01B 31/125; B01J 19/18; B01J 2219/00051

(57) ABSTRACT

An apparatus for making an alkali activated carbon, as defined herein, including:
a first chamber to combine a carbon and an alkali, free of foaming, to form a billet;
a second chamber comprising: a hot zone; and a cold zone;
an optional third chamber for washing the cooled billet; and
a conveyor that receives carbon and an alkali materials in the first chamber and conveys a mixture of reactants to the second chamber, and then optionally conveys the cooled billet to the optional third chamber. Also disclosed are method of making alkali activated carbon in the disclosed apparatus.

The entire disclosure of publications and patent documents mentioned herein are incorporated by reference.

### BACKGROUND

The present disclosure relates generally to the field of alkali chemical activation processes for the manufacture of activated carbon.

### SUMMARY

In embodiments, the disclosure provides an apparatus and methods of making activated carbon, for example, in batch, semi-continuously, or continuously. In embodiments, the disclosure provides a method and an apparatus for suppressing foam and minimizing corrosion during alkali activation of carbon.

### BRIEF DESCRIPTION OF THE DRAWINGS

In embodiments of the disclosure:

FIG. 1 shows a process flow diagram (100) for a low cost KOH chemical activation process.

FIGS. 2A and 2B, respectively, show a resulting C:KOH mound from a continuous feed experiment (FIG. 2A), and temperature and power data versus time from a continuous feed experiment (FIG. 2B).

FIG. 3 shows a schematic of an exterior elevation view of the apparatus (300) used for the continuous activation process.

FIG. 4 shows the apparatus (300) of FIG. 3 in cross-section and aspects and events during the initial formation (800A) and growth (800B) of a billet from the carbon and alkali batch material with progressive feeding.

FIG. 5 shows the apparatus (300) of FIG. 3 in cross-section and aspects and events at a later time in formation and further growth (800C) and termination point (800D) of the billet of the carbon and alkali material with progressive feeding at steady state, with continuous movement of the billet downward due to removal of activated material through the holes in the pedestal (800).

FIGS. 6A and 6B show details of the alkali (e.g., hot KOH) feeder in perspective (FIG. 6A) and in cross section (FIG. 6B) for dispensing fresh alkali hydroxide material onto a previously dispensed carbon powder layer.

FIG. 7 shows the carbon feeder in perspective used in conjunction with the alkali feeder of FIG. 6 and the apparatus of FIG. 3.

FIG. 8 shows the pedestal component (800) of the apparatus of FIG. 3 in perspective.

FIG. 9 shows the wash tank (341) component of the apparatus (300) of FIG. 3.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### DEFINITIONS

“Activation,” “activate,” and like terms refer to creating pores in the carbon product to create a high surface area property, as defined herein. Activation is mentioned in commonly owned and assigned U.S. Pat. No. 8,252,716.

“Progressive layering” refers to continuously depositing a layer of the admixture, or the simultaneously, yet separately, depositing layers of the components prior to admixture.

“Slight oxidizing atmosphere” refers to the atmosphere within the apparatus and the atmosphere can include, for example, steam, oxygen, air, or combinations thereof.

“Fugitive layer” refers to a film, screen, or like barrier, which prevents the billet from fouling or plugging the wash spray apertures in the rotating disk conveyor or pedestal, and which layer can be readily disintegrated with the action of the wash water. An example of a suitable fugitive layer is GRAFOIL®.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The apparatus and methods of the disclosure can include any value or any combination of the values, specific values, more specific values, and preferred values described herein, including explicit or implicit intermediate values and ranges.

The present disclosure relates generally to the field of alkali chemical activation processes for the manufacture of activated carbon at low cost. The present disclosure also relates to the use of a continuous process to chemically activate carbon material. The continuous process of the disclosure enables significant reduction in corrosion, foaming, and potassium vaporization, that have typically plagued chemical activation process. Alkali activated carbons find application in energy storage devices such as electric double layer capacitors where a large surface area is required.

An electric double layer capacitor, also known as an ultracapacitor, is a device having high power densities and relatively high energy densities compared to conventional electrolytic capacitors. U.S. Pat. No. 8,760,851, mentions and shows the structure of a representative EDLC. EDLC's utilize high surface area electrode materials and thin dielectric double layer to achieve capacitance that is several orders of magnitude higher than conventional capacitors. This allows them to be used for energy storage rather than general purpose circuit components. Typical applications include, for example, micro-hybrid and mild hybrid automobiles. A typical EDLC device consists of positive and negative electrode laminated onto aluminum current collector foil. The two electrodes are separated by a porous separator paper in between and wound to make a jelly roll-like structure, which is then packaged in an enclosure containing organic electrolyte. The porous paper between the positive and negative electrodes allows flow of ionic charge, but at same time prevents transfer of electrons between the two electrodes. With potential applications in, for example, the automotive sector, there is a motivation towards higher energy density, higher power density, and lower cost. These requirements create a need for increased capacitance, widening of the electrolyte operating window, and decreasing the equivalent series resistance (ESR). Significant characteristics of these devices include the energy density and power density, which are determined by the properties of the carbon that is incorporated into the electrodes and electronic resistance at the current collector/electrode interface.

Carbon-based electrodes suitable for incorporation into energy storage devices are known. Activated carbon is widely used as a porous material in ultracapacitors due to its large surface area, electronic conductivity, ionic capacitance, chemical stability, low cost, or a combination thereof. Activated carbon can be made from natural precursor or carbon source materials, such as coals, nut shells, and biomass, or synthetic materials such as phenolic resins. With both natural and synthetic precursors, the activated carbon can be formed by carbonizing the precursor and then activating the intermediate product. The activation can comprise physical activation (e.g., steam or CO₂) or chemical activation at elevated temperatures to increase the porosity and hence the surface area of the carbon. Several chemical reagents have been used in the art, including for example, KOH, NaOH, LiOH, H₃PO₄, Na₂CO₃, KCl, NaCl, MgCl₂, AlCl₃, P₂O₅, K₂CO₃, K₂S, KCNS, ZnCl₂, or mixtures thereof. However, the use of alkali metal hydroxides, such as KOH or NaOH, has been widely adopted to achieve various desirable properties.

For achieving higher capacitance, activated carbons with high surface (e.g., 500 to 2500 m²/g) have been utilized. More recently, engineered carbons have been developed to achieve higher specific capacitance, but the cost of these materials is still too high for use in commercial products. The state-of-the-art EDLC device utilizes steam activated carbon. These steam activated carbons are produced from a carbonized carbon precursors (e.g., coconut shell, wheat flour, coke, etc.). The chemical activation process has significant manufacturing issues resulting in higher cost, and these issues have inhibited widespread use of chemically activated carbon in EDLC irrespective of their desired characteristics such as high capacitance.

Both physical and chemical activation processes typically involve large thermal budgets to heat and react the carbonized material with the activating agent. For chemical activation, corrosive by-products can be formed when a carbonized material is heated and reacted with caustic chemical activating agents such as alkali metal hydroxides. Additionally, phase changes, or fluxing, may occur during the heating and reacting of the carbonized material and chemical activating agent, which can result in agglomeration of the mixture during processing. Furthermore, alkali metal can evaporate from the batch and get deposited in the furnace or escape with the off-gases creating potential safety issues. These drawbacks can add complexity and cost to the overall process, particularly for reactions that are carried out at elevated temperatures for extended periods of time.

Additionally, chemical activation using alkali metal hydroxides can result in the release of several gases (e.g., CO, CO₂, H₂, and H₂O) during processing, which can lead to the formation of foam. Foaming during activation tends to limit the amount of material that can be processed in the activation reactor. For instance, in some cases, only about 10 to 30 vol %, for example about 20 vol %, of the crucible volume can be used for the feedstock mixture to account for foaming during processing. The corrosive nature of the feedstock mixture called for using reactors constructed using costly and corrosion-resistant materials such as silicon carbide. The present disclosure provides a chemical activation process that minimizes the corrosion issue and allows for an increased throughput.

Prior art methods to avoid foaming during processing involve, for example, the use of compacted feedstock pellets. The pellets are made, e.g., by vacuum drying the feedstock mixture for several hours, or by pressing the feedstock mixture that has a binder. The resulting pellets can then be activated and processed in solid, pelletized form. However, the extra step of vacuum drying, or having an extra binder component and pressing operation, tend to increase the cost of the process.

In embodiments, the present disclosure provides an activated carbon material and processes for forming activated carbon materials using a more economical chemical activation route, while also minimizing issues relating to corrosion, foaming, and potassium vaporization. The resulting activated carbon materials possess higher capacitance due to relatively higher micro-pore volume, and that enable high energy density devices.

The present disclosure provides a solution to the abovementioned process problems of corrosion, foaming, and potassium vaporization. The solution ideally should be scalable, should not add significant cost to the process, and should also not degrade product performance in any way.

In embodiments, the disclosure provides a continuous process to chemically activate carbon material. The disclosure process provides a robust, simple, and low cost alkali chemical activation process.

In embodiments, the disclosure provides an apparatus and methods of making and use for a low cost continuous chemical activation process that takes into account changes in batch rheology during heating, mechanisms of potassium vaporization, and kinetics of activation reaction. The use of the disclosed process and apparatus provides a contact-free activation process and significantly reduces corrosion issues. The disclosed apparatus and methods use progressive feeding of a pre-heated batch mixture, which allows for immediate or faster de-foaming and provides for higher process throughput compared to a batch which is not progressively fed. The continuous disposition of the disclosed process enables processing of a limited amounts of material at any given point in the high temperature heat zone of reactor, which significantly reduces safety concerns of processing the alkali activated carbon. Furthermore, this approach leads to formation of a continuous solid billet having a low surface to volume ratio after a de-foaming step. The low surface to volume ratio significantly reduces potassium vaporization from the billet during the activation step. Furthermore, a slightly oxidizing environment in the high temperature portion of the apparatus ensures oxidization of any trace amount of elemental potassium that may escape from the billet surface.

In embodiments, the disclosed method and apparatus are advantaged in several respects, including, for example:

The batch, semi-continuous, or continuous activation process is a robust and low cost alkali chemical activation process.

The process is substantially free of physical contact of the processed material with the furnace portion of the apparatus and thus significantly reduces corrosion by the caustic alkali materials. Furthermore, a contact-free furnace surface leads to lower levels of contamination in the product from furnace materials.

The progressive delivery of a pre-heated batch material allows for quick de-foaming and increases process throughput.

The stirring of a hot KOH melt allows removal of water before the KOH contacts the carbon material reducing the amount gas, which gas is responsible for foaming.

The continuously formed solid billet having a lower surface to volume ratio reduces potassium vaporization from the billet during the activation step.

The use of a slightly oxidizing condition in the furnace oxidizes any trace amounts of metallic potassium that may escape from the billet surface during the activation step.

The activated carbon produced from the disclosed continuous method does not degrade the EDLC product performance.

The continuous state of the process enables processing of limited amounts or small amounts of material at any given point in the high temperature heat zone of the reactor, which significantly reduces safety concerns of processing alkali activated carbon.

In embodiments, the disclosed method of making alkali activated carbon is advantaged by minimizing or eliminating foaming by progressive feeding of batch materials and without the need for a pelletization, a briquetting, or a granulation step; minimizing contact of the corrosive alkali activated carbon batch materials with furnace elements and significantly reducing corrosion; the slightly oxidizing atmosphere in the furnace environment converts metallic potassium vapor into more stable compounds eliminating safety issues; and the billet product in continuously washed, purified, and activated.

In embodiments, the disclosure provides an apparatus for making an alkali activated carbon, comprising:

a first chamber for receiving, layering, and defoaming, a mixture of a carbon powder and an alkali hydroxide at from 300° C. to 600° C., to form a billet;

a second chamber comprising:
a hot zone for receiving the defoamed billet and heating the defoamed billet to from 750° C. to 900° C., to form a hot billet and to initiate carbon activation; and
a cold zone for cooling the hot billet to form a cooled billet;

a third chamber for washing the cooled billet received from the cold zone to dissolve water soluble salts and to disperse the alkali treated carbon product in the wash water; and

a conveyor that receives the carbon powder and the alkali hydroxide in the first chamber, and conveys the layered mixture into and through the second chamber, and then conveys the resulting cooled billet to the third chamber for washing.

In embodiments, the conveyor can be, for example, a rotating disk.

In embodiments, the conveyor can be, for example, a rotating disk that conveys by vertical displacement.

In embodiments, the disclosure provides an apparatus for continuously making an alkali activated carbon, comprising:

a first chamber for simultaneously and continuously receiving, continuously layering, and continuously defoaming a mixture of carbon powder and an alkali hydroxide at from 300° C. to 600° C., to continuously form a billet;

a second chamber comprising:
a hot zone for continuously receiving the defoamed billet and continuously heating the defoamed billet to from 750° C. to 900° C. to initiate carbon activation; and
a cold zone for continuously cooling the growing hot billet to form a growing cooled billet;

a third chamber for continuously washing the growing cooled billet emerging from the cold zone to dissolve water soluble salts and to disperse the activated carbon product in the wash water; and

a rotating disk conveyor that receives batch materials in the first chamber and conveys the layered mixture into and through the second chamber, and then conveys the resulting growing cooled billet to the third chamber for washing.

In embodiments, the apparatus can further comprise an antechamber situated before the first chamber for preheating the carbon powder and an alkali hydroxide to at least 500° C. prior to delivery to the first chamber, for example, preheating separately or in admixture.

In embodiments, layering or continuously layering in the first chamber can include, for example, at least one of:

depositing a layer of the mixture of the carbon powder and the alkali hydroxide;

alternately depositing a layer of the carbon powder atop a layer of the alkali hydroxide;

alternately depositing a layer of the alkali hydroxide atop a layer of the carbon powder;

or a combination thereof.

In embodiments, the rotating disk conveyor can rotate at, for example, from 1 to 10 revolutions per minute, and the rotating disk conveyor conveys by vertical displacement at, for example, from 0.1 to 1 inch per minute.

In embodiments, the rotating disk conveyor, i.e., pedestal, can include, for example, a plurality of apertures (820) for delivering a water spray to the billet when the rotating disk is fully conveyed to the third chamber, that is, for example, when the disk reaches the end or bottom of the third chamber of the conveyance conduit.

In embodiments, the rotating disk conveyor, i.e., pedestal, can include, for example, a plurality of apertures or drain holes (810) that permit liquid dispersed particles to pass through the pedestal and be swept out of the third chamber for isolation and further processing.

In embodiments, the rotating disk conveyor can include, for example, a fugitive separator film or screen member that prevents the billet from fouling or plugging the apertures of the pedestal, for example, during initial billet formation.

In embodiments, the first, second, or third chambers can include, for example, a liner selected from at least one of: silicon carbide, e.g., SiC (Hexoloy® SA grade), nickel, a high-content nickel alloy, or a combination thereof.

In embodiments, the batch-wise, semi-continuously, or continuously formed billet does not have substantial physical contact the surface of the second chamber.

In embodiments, the apparatus has an activated carbon throughput capacity of, for example, from about 5 to 200 kilograms per hour.

In embodiments, the disclosure provides a method of making an alkali activated carbon in the above described apparatus, comprising:

conveying the formed billet comprising a the layered mixture of carbon powder and an alkali hydroxide from the first chamber to the second chamber, i.e., the first stage of a two stage conveying furnace, and simultaneously heating, optionally in an oxidizing atmosphere, the conveyed layered mixture in the hot zone of the second chamber to from 750° C. to 900° C. to activate the carbon in the billet; and

conveying the growing hot billet from the hot zone to the cold zone of the second chamber to form a cooled billet.

In embodiments, washing the billet of the alkali activated carbon product with a water spray causes or promotes continuous downward movement of the activated carbon product, i.e., so that the billet can continue to advance in the downward direction under the influence of gravity, continued conveyance, or both

In embodiments, the method can further comprise conveying the growing cooled billet to the third chamber to wash and erode the cooled billet and suspend the activated carbon product in the wash; and

isolating the alkali activated carbon, comprising separating the dispersed activated carbon product from the wash water, drying the carbon product, and heating the carbon product at from 600 to 1,000° C. for 1 to 6 hours in a reducing atmosphere.

In embodiments, the method can further comprise preheating the carbon powder and an alkali hydroxide to at least 500° C. prior to delivery to the first chamber.

In embodiments, the method can further comprise isolating the alkali activated carbon, comprising separating the activated carbon product dispersed in the wash water, drying, and heating at from 600 to 1,000° C., such as from 650 to 700° C., for 1 to 6 hours in (i.e., in the presence of) a reducing atmosphere (e.g., 0.1 to 10 vol %, such as 1 vol % hydrogen gas in nitrogen).

In embodiments, the disclosure provides a method for managing foam, that is minimizing, eliminating, or controlling foam formation, in the manufacture of alkali activated carbon.

In embodiments, the disclosed apparatus can include, for example, a rotating disc, a rotating drum, a conveyor belt, and like instrumentalities, that can receive measured amounts of solid or liquid (solution and suspensions) mixtures of carbon and alkali hydroxide and provide a large receiving surface area. The large receiving surface area provides for facile exothermic heat evolution and gas dissipation without entrapment of heat or gas by the reactants, intermediates, or product(s), and minimizes or eliminates bubble formation or foam formation (also known herein after as “progressive defoaming”).

In embodiments, preheating the carbon powder and an alkali hydroxide prior to delivery to the first chamber produces a layered mixture free of foam.

In embodiments, the layered mixture of carbon powder and an alkali hydroxide is a dry admixture.

In embodiments, the layered mixture of the carbon powder and the alkali hydroxide (MOH) has a weight ratio of carbon:MOH of from 1:1 to 1:3.

In embodiments, the layered mixture of the carbon powder (C) and the alkali hydroxide (MOH) has a weight ratio of carbon:MOH of 1:2, i.e., C:MOH=1:2 by weight.

In embodiments, the carbon powder has a D₅₀ of 5 micrometers and the alkali hydroxide is potassium hydroxide.

In embodiments, the growing hot billet can have limited physical contact (i.e., temporally with respect to residence or transit time and with respect to surface area contact) with the internal surfaces of the apparatus (and minimizes corrosion of the furnace), and the optional oxidizing atmosphere converts any metallic potassium vapor into a less volatile and more stable product (for example, KOH, K₂O, or K₂CO₃ salts), and reduces or eliminates potential potassium vapor safety issues.

In embodiments, the present disclosure provides a robust, simple, and low cost alkali chemical activation process that uses a batch, semi-continuous, or continuous-feed approach to the manufacture of activated carbon. The batch, semi-continuous, or continuous process resolves corrosion, foaming, and potassium vaporization issues that have disadvantaged conventional approaches for making alkali chemical activated carbon.

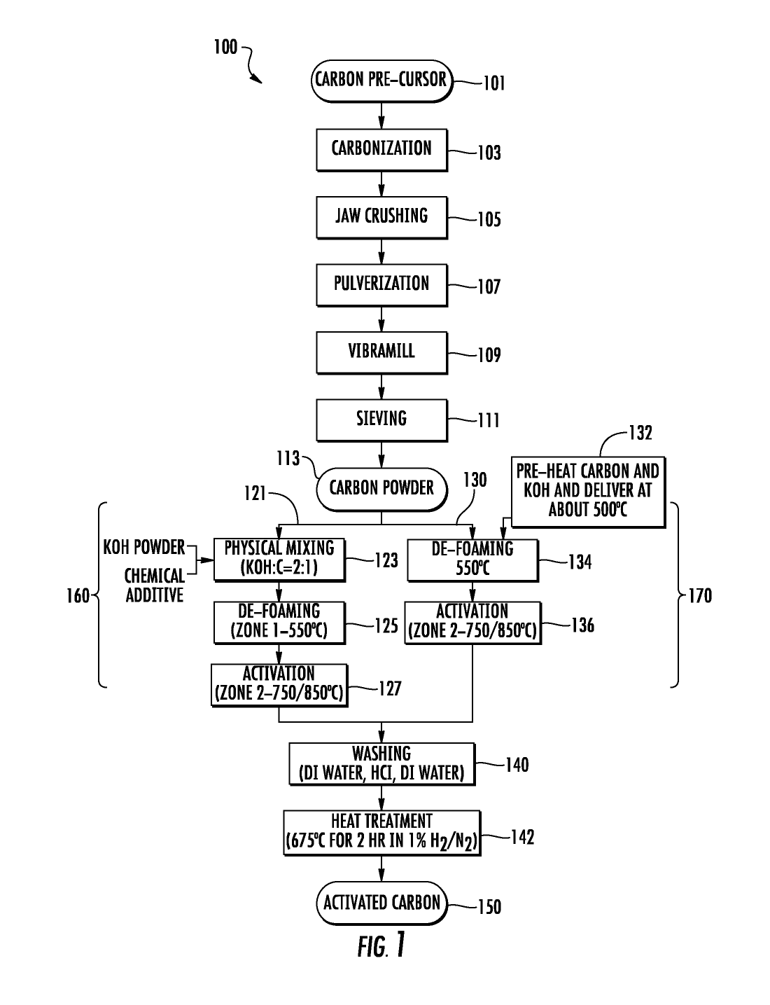

Referring to the Figures, FIG. 1 shows a process flow diagram for the KOH chemical activation process (100). Starting with carbon pre-cursor (101) or source of carbon, the carbonization process (103), including for example, a nitrogen gas purge, ramp rate heating a 150° C. per hr to 800° C., hold a 800° C. for 2 hr, then furnace cool to below 70° C., removes volatile elements from the pre-cursor. The carbonized material was ground with, for example, jaw crushing (105), pulverization (107), vibramilling (109), and sieving (111), to a desired particle size of, for example, 5 to 150 microns average particle size.

FIG. 1 also shows process variation embodiments. In embodiment (160), the carbon and KOH can first be physically mixed (123) at ambient temperatures to form a physical mixture. The mixture physical can then be delivered to the disclosed apparatus for defoaming (125) with the temperature set at, for example, about 550° C., and then a heat or a thermal activation step (127) with the temperature set at, for example, about 750 to 850° C.

In embodiment (170), the carbon and KOH can be separately pre-heated each at about 500° C. (132) and then delivered to the apparatus for progressive defoaming (134) with the temperature set at, for example, about 550° C., and then a heat or thermal activation (136) with the temperature set at about 750 to 850° C. Additional processing steps, such as washing (140) and heat treatment (142) are discussed below.

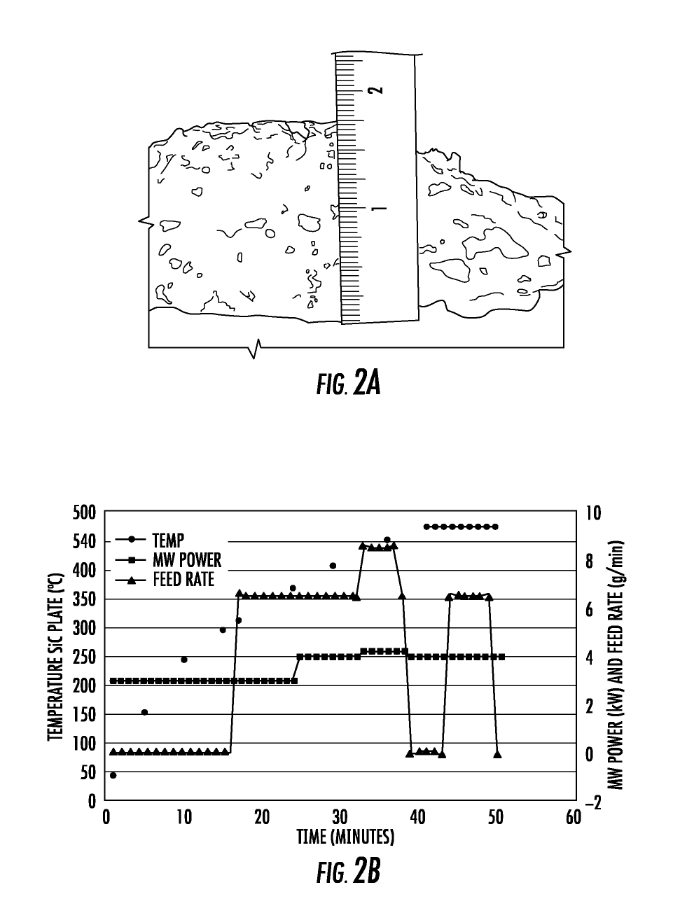

FIGS. 2A and 2B, respectively, show a resulting C:KOH mound from a continuous feed experiment of, for example, about 200 g of total material (FIG. 2A), and temperature and microwave power data versus time from a continuous feed experiment (FIG. 2B).

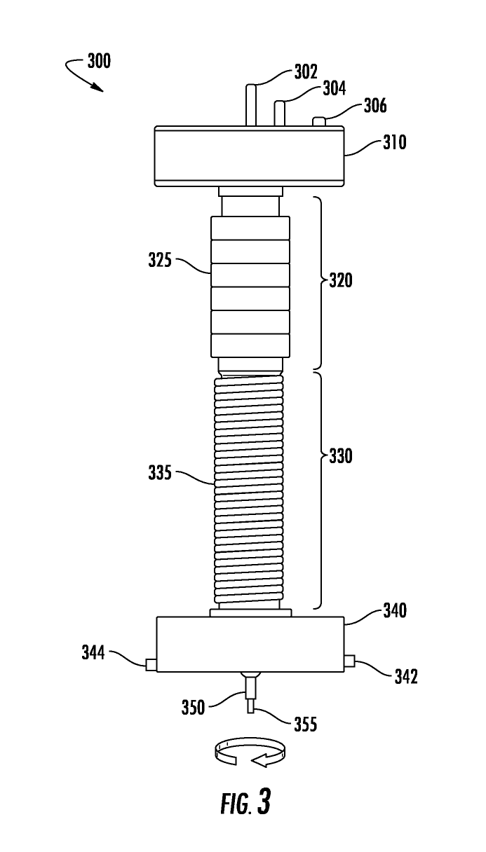

FIG. 3 shows a schematic of an exterior elevation view of the disclosed apparatus (300) used for the disclosed continuous or progressive activation process. In embodiments, the disclosed apparatus can include, for example, a first chamber (310) for combining, preheating, or both, the carbon and alkali hydroxide, including a reactor vent (302), an alkali hydroxide feeder vent (304), and an alkali hydroxide inlet (306). The first chamber (310) is adjacent to a second chamber, the second chamber having a hot section (320) and cold section (330), which sections include a hot zone (325) and a cold zone (335), respectively.

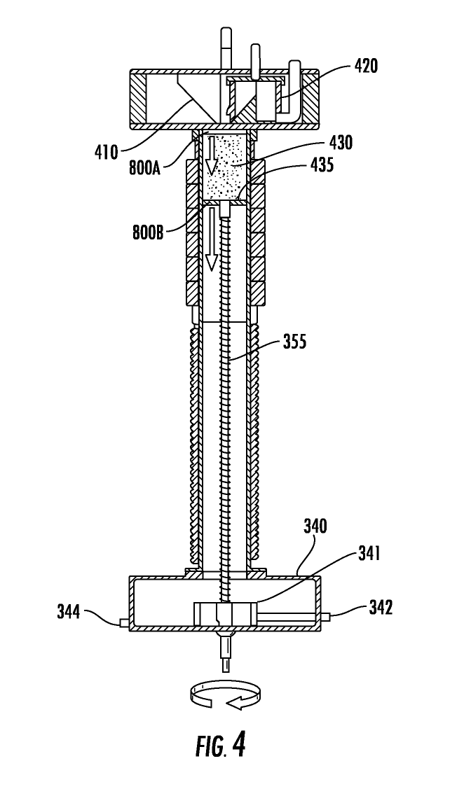

The second chamber is adjacent to a third chamber, the third chamber (340) being adapted to stepwise or continuously wash the growing or emerging billet, including a water inlet (342) and a slurry or dispersion outlet (344), a shaft (350) for rotating the rotating disk or pedestal (800)(shown in FIG. 4), a threaded shaft (355) for changing the position of the rotating disk, that is, raising or lowering the rotating disk or pedestal, within the long dimension of the apparatus, about the axis of the rotating shaft (350). In embodiments, the threaded shaft (355) can provide any of, for example, support for the pedestal, rotation of the pedestal, vertical displacement of the pedestal, or combinations thereof.

FIG. 4 shows the apparatus (300) of FIG. 3 in cross-section, and aspects and events during the initial billet formation (800A) on a rotating disk conveyor, and progressive billet growth (800B) on the progressively downwardly advancing rotating disk, formed from the carbon and alkali batch materials with progressive feeding. In embodiments, the threaded shaft (355) may or may not be present above the pedestal (800)(e.g., not shown above the pedestal in FIG. 3 since absent, whereas shown in phantom lines above the pedestal in FIG. 4 since present). Other features of the apparatus (300) of FIG. 3 that are shown in FIG. 4 include: a carbon feeder (410), an alkali hydroxide feeder (420), for example, for dispensing the carbon and the hydroxide, respectively, such as a powder, a solution, a suspension, a molten liquid, or combinations, to form a mixture of the carbon and the hydroxide as a growing billet (430) on the a frangible membrane (435). Other illustrated aspects include the aforementioned third chamber (340), wash tank (341), the water inlet (342), the slurry or dispersion outlet (344), and the shaft (350). Other illustrated aspects include activated fountains (820) spraying water upwards, and degraded or eroded billet particles flowing through the pedestal (800C).

FIG. 5 shows the apparatus (300) of FIG. 3 in cross-section and aspects and events at a later time in formation and further billet growth (800C) and billet (430) full growth or termination point (800D) from progressive feeding of the carbon batch material at steady state. The continuous movement of the billet downward is attributable to continued feeding and removal of the combined carbon and alkali mixture by washing or irrigation the billet in the third chamber by dispensing a wash liquid, such as water, through the holes in the pedestal (800) to generate the carbon liquid dispersion (510).

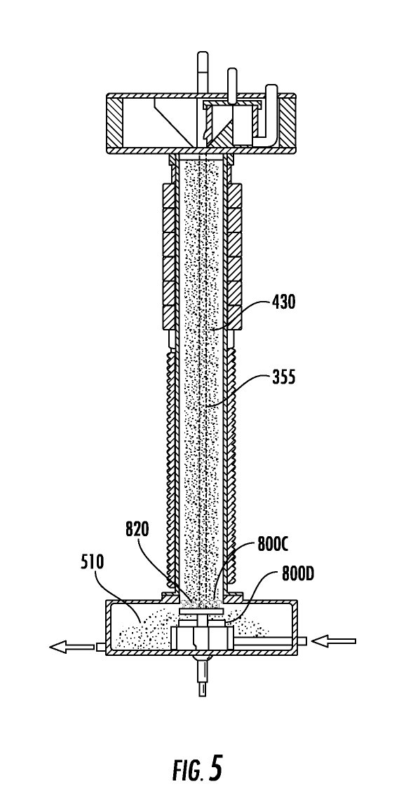

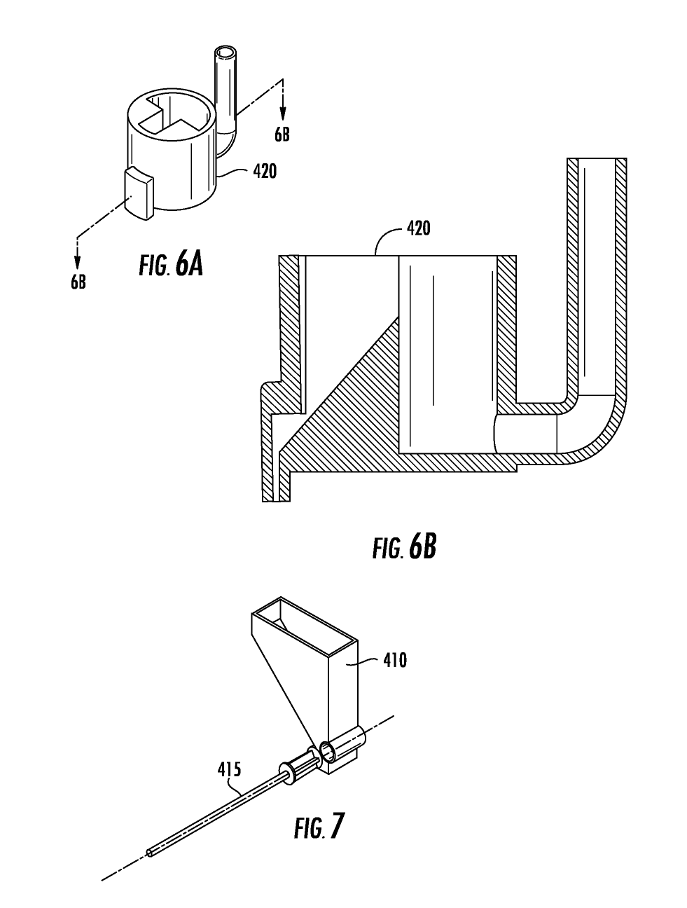

FIGS. 6A and 6B show details of the hot KOH feeder (420) in perspective (FIG. 6A) and in cross section (FIG. 6B) for dispensing fresh alkali hydroxide material onto previously dispensed carbon powder layer.

FIG. 7 shows, in perspective, an exemplary carbon feeder (410) used in conjunction with the KOH feeder of FIG. 6 and the apparatus of FIG. 3. The carbon feeder (410) can have, for example, a manual or robotically controlled dispense wheel and associated drive shaft (415). The carbon feeder can optionally be coupled to the alkali feeder for coordinated feeding.

In embodiments, the rotation and vertical displacement of the disk conveyor (800) can be coupled to either or both the alkali feeder (420) and the carbon feeder (410) so that measured dispensing of the feed materials is coordinated with the conveyor.

FIG. 8 shows the pedestal component (800) of the apparatus of FIG. 3 in perspective. The pedestal can be covered with a liquid frangible sheet, for example, a water erodible sheet (not shown), such as GRAFOIL®, to prevent initial molten or solid product from fouling the drain holes or drain apertures (810) or fountain aperture nozzles (820). The apertures or nozzles provide one or more fountain aperture nozzle (820) of an aqueous or water spray for eroding and washing away the batch formed, semi-continuously formed, or continuously formed billet product.

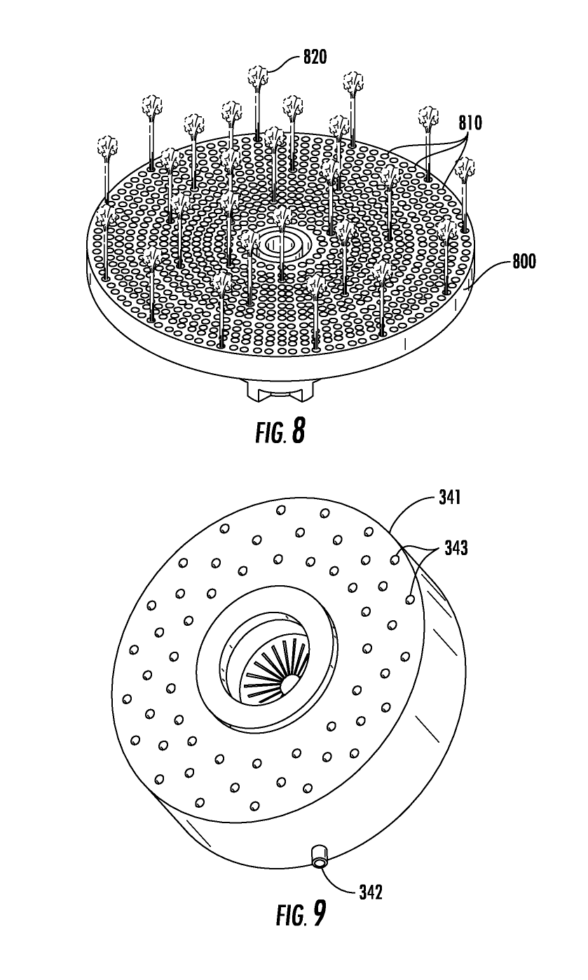

FIG. 9 shows the wash tank (341) component of the apparatus (300) of FIG. 3. The wash tank (341) receives wash water from a water source at receptacle (342), and delivers the wash water to the pedestal (800) through, for example, the irrigation apertures (343) to the fountain nozzle apertures (820) when the pedestal engages the wash tank (341) and after the pedestal (800) has descended through the heated zone (320) and cooling zone (330) of the reactor apparatus (300). In embodiments, the pedestal (800) can be constructed without irrigation apertures (343) or the fountain nozzle apertures (820). Instead a knife edge can be engaged with the base of the billet to initiate mechanical degradation followed by the water erosion and washing.

In embodiments, the KOH and the crushed carbon powder (weight ratio of KOH:C from 1:1 to 5:1), in admixture or separately, are progressively fed onto a rotating flat disk conveyor or pedestal (800) as shown in FIG. 8.

To begin the process, the drain holes (810) in the pedestal (800) (FIG. 8) of the conveying furnace shown in FIG. 3, can be covered with a fugitive protective layer of GRAFOIL® (not shown). To allow mixing of batch materials, thin layers of carbon and KOH are formed on top of each other by delivering carbon and KOH separately using the carbon (410) feeder and KOH (420) feeder shown in FIG. 4 (and feeders shown in isolation in FIGS. 6 and 7). The KOH delivered on top of carbon layer infiltrates into carbon powder and reacts with it forming solid layer. The thickness of the carbon and KOH layers can be controlled by the feed rate of batch materials and rotation speed of the pedestal. The temperature in the feeding zone was set to about 550° C. Due to high surface area available for the gases to escape, de-foaming (i.e., degassing) of the deposited material takes place very rapidly. Due to chemical reactions between carbon and KOH, the viscosity of the material increases rapidly at about 500° C. Some of the possible chemical reactions are in equations 2 to 4 below.

In embodiments, the rotating pedestal (800) can continuously move downward into the furnace at a rate at which a de-foamed solid layer (430) can form. The batch materials can be continuously delivered on top of the de-foamed material that was converted into a solid mass due to reactions between carbon and KOH. The solid billet (mixture of potassium compounds and carbon) forms continuously as the pedestal moves downward into activation zone or hot zone (320) where the temperature can be, for example, 750 to 850° C. In embodiments, the batch materials are preferably pre-heated to about 500° C. before being delivered onto the pedestal to increase the furnace throughput (embodiment (160) in FIG. 1). Higher temperatures in activation zone or hot zone (320) can cause conversion of KOH into K₂CO₃ due to reaction with carbon (KOH has a melting point of 406° C.; K₂CO₃ has a melting point of 891° C.). The potassium compounds (K₂O, K₂CO₃) can also be reduced by carbon to produce metallic potassium at elevated temperatures above about 500° C. (eqs. 9 and 10) of the process. The metallic potassium intercalates into the carbon matrix (eq. 11), and after washing creates micro-porosity in the resulting carbon matrix.

Although not limited by theory, it is believed that some of the elemental potassium shown in eqs. 6, 9, and 10, vaporizes and can be deposited in the interior of furnace or escapes with flue gases in conventional alkali chemical activation process. In the disclosed process, the furnace atmosphere can be controlled to maintain slightly oxidizing conditions by introduction of steam, air, or oxygen, sufficient enough to convert the potassium vapor into a less volatile and more stable form or product (e.g., KOH, K₂O, or K₂CO₃) and eliminating potassium metal deposits, which permits safe operation of the process. The furnace environment can be very close to a neutral environment since steam or air introduced will be consumed by potassium vapor. The potassium metal has a vapor pressure of 123 mm Hg at 570 to 600° C., and 392 mm Hg at 685 to 700° C.

KOH.xH₂O→KOH+xH₂O (1)

2KOH→K₂O+H₂O (2)

C+H₂O→CO+H₂ (3)

CO+H₂O→CO₂+H₂ (4)

CO₂+K₂O→K₂CO₃ (5)

6KOH+2C→2K+3H₂+2K₂CO₃ (6)

K₂CO₃→K₂O+CO₂ (7)

CO₂+C→2CO (8)

K₂CO₃+2C→2K+3CO (9)

C+K₂O→2K+CO (10)

K+nC→KCₙ (11)

After activation, the billet or log goes through a cooling zone (330) to reduce its temperature to less than 100° C.). The cooled billet enters into washing chamber (340) where water is supplied through selected holes (810) in the pedestal (800) that correspond to apertures (343) to dissolve the activated material. The pedestal stops descending when washing starts as shown in FIG. 5. The dissolution of water soluble inorganic binder by-product, such as K₂CO₃, makes solid material at the bottom of the billet disintegrate and allows the downward movement of the activated material billet due to gravity or continued conveyance. The water spray sweeps the activated carbon material from the billet and carries the resulting slurry or dispersion penetrating through the drain holes (810) to the cleaning and filtering step. The pedestal (800) and washer or wash spray (820) and wash tank (341) are shown in FIG. 8 and FIG. 9, respectively. In embodiments, the wash tank (341) can have water source apertures (343), which can direct water flow to the corresponding water fountain apertures (820) in the pedestal (800). The exiting slurry (510), that is, the carbon dispersed in an aqueous alkali solution, is collected, and then filtration and acid washing steps (140) remove, for example, potassium, potassium compounds, and other impurities from the carbon. The washed carbon is then heat treated (142) in a forming gas environment at, for example, greater than 675° C., to reduce the oxygen containing functional groups on the surface of carbon. The reduction of oxygen containing functional groups in the resulting activated carbon product (150) improves the long term durability of the EDLC.

### Manufacturing Scenarios and Production Throughput

An advantage of the disclosed continuous KOH chemical activation process is the production throughput. The continuous nature of the process permits small amounts of material to be processed, which significantly reduces any safety concerns associated with fugitive elemental potassium. As noted in Table 1, for example, a 10 inch diameter tube (25.4 cm) reactor can process up to 60 metric tons (MT) of activated carbon per year. Typical length of the reactor can be about 12 feet (360 cm). The pre-heat zone extends 1 foot (30 cm), followed by activation zone which is about 2 feet long (60 cm). The cooling zone is about 5 feet (150 cm) long, followed by washing zone of about 2 feet (60 cm). The scale-up to larger volumes can be achieved by increasing the reactor tube diameter, which increases the volumetric flow rate of processed material. The size of the equipment for 238 MT/year and 954 MT/year activated carbon production scenarios are provided in Table 1. In all instances the height of the furnace is about 12 feet.

TABLE 1
Manufacturing scenarios for continuous KOH activation process.

| | Units | Plant 1 | Plant 2 | Plant 3 |
|---|---|---|---|---|
| Diameter | cm | 25.4 | 50.8 | 101.6 |
| | ft | 0.8 | 1.7 | 3.3 |
| Billet Cross-section area | cm² | 506.9 | 2027.6 | 8110.6 |
| Linear speed | cm/min | 0.5 | 0.5 | 0.5 |
| Volumetric Flow | cc/min | 253.5 | 1013.8 | 4055.3 |
| Density | g/cc | 2.0 | 2.0 | 2.0 |
| Gravimetric Flow | g/min | 506.9 | 2027.6 | 8110.6 |
| Activated Carbon | g/min | 118.3 | 473.1 | 1892.5 |
| Production (Throughput) | kg/hr | 7.1 | 28.4 | 113.5 |
| | kg/day | 170.3 | 681.3 | 2725.2 |
| | MT/yr | 60 | 238 | 954 |

In embodiments, the disclosed continuous process uses progressive feeding of batch materials. The progressive feeding permits easy removal of gases due to a high surface to volume ratio without causing too much foaming. In embodiments, the disclosure provides for the use of a low surface to volume billet during activation that leads to reduction in potassium vaporization from the billet. The water vapor from the washing chamber maintains slightly oxidizing conditions in the furnace to react with potassium vapor allowing safe operation of the furnace.

### EXAMPLES

The following Examples demonstrate the making of activated carbon with the disclosed apparatus in accordance with the above general procedures. The following Examples also demonstrate variations of selected operating parameters used in the disclosed method and apparatus.

### Comparative Example 1

### Conventional Batch Process

### Carbon Powder Preparation

A carbon feedstock was prepared by carbonizing wheat flower in the presence of nitrogen at about 800° C., using an average ramp rate of about 150° C., and a hold time of about 2 hours. The carbonized material was then pulverized, crushed, milled, and sieved to yield a carbon powder having an average particle size (D₅₀) of about 5 microns+/−0.25 microns.

Carbon and KOH Mixing with Significant Foaming

The carbon feedstock was combined with KOH powder in weight ratio of 1:2. The feedstock mixture was charged into a crucible, filling approximately 20% of the crucible volume, and placed in a furnace with a conventional heating source. The fill volume was kept at 20% to make sure the foamed material does not overflow the crucible. A solid porous block forms at the end of the foaming process. With continued heating at ramp rate of 150° C./hr in flowing inert nitrogen gas the porous block gets activated at temperatures of, for example, 750° C. to 900° C., of 750° C. to 850° C., and like temperatures, including intermediate values and ranges.

### Washing and Heat Treatment of the Activated Carbon

The activated carbon was washed (140) by rinsing with deionized water several times until most of the potassium and potassium compounds are removed from carbon. Finally the carbon material is washed with hydrochloric acid, and subsequently subjected to heat treatment (142), for example, at about 675° C. for about 2 hr in the presence of a forming gas (e.g., 1% H₂/N₂). The washed and heat treated activated carbon (150) was characterized by surface area, and pore volume. The specific surface area and pore volume were 1700 to 2000 m²/g and 0.70 cm³/g, respectively. The percentage of pores with a diameter less than 20 nm was greater than 90%. Button cells were made with the activated carbon, and yielded a capacitance performance of 90 F/cc. The amount of potassium vaporization in the batch was measured at approximately 10 wt % based on the total potassium in the batch from the activation.

### Example 2

### Demonstration of Low-Foam Continuous Progressive Feeding

### Manual Feed

A carbon feedstock powder (having particles of about 5 micrometers diameter) was prepared using the method described in Comparative Example 1. The carbon powder was mixed with KOH powder in weight ratio of 1:2 using a mixer for at least 30 minutes until the batch was homogenous. An empty 2 inch deep tray with 10.25 inch internal diameter was weighed and placed in a furnace to act as a crucible. The empty crucible weighed about 2.389 kg. The furnace was turned on and initially heated to a temperature of about 550° C. The furnace had a 2.5″ port at the top that was used as a feed inlet. A view window at the front of the furnace allows an operator to view the phenomena inside the furnace.

The carbon and KOH mixture was manually fed intermittently into a crucible via a funnel. 20 g of a batch mixture was weighed and manually fed into the crucible via a funnel. The material melted into a thin film and no foaming was observed. The material solidified in about 2 minutes. Next, 50 g of the batch mixture was weighed and manually delivered into the crucible via the funnel. The material melted into a thin film. No active foaming was observed. After a few isolated bubbles, the material solidified in about 4 minutes. Another 50 g batch mixture was weighed and charged into the furnace on top of the dried batch, following the same previous steps. Again the added batch mixture material melted into a thin film and no active foaming was noticed. The material solidified in about 4 minutes. Another 100 g batch mixture was weighed and delivered via the funnel. The batch mixture melted into a thin film. After a few isolated bubbles the batch melt solidified in about 7 minutes.

The furnace temperature was then increased to 700° C. 100 g of a batch was weighed and delivered via the funnel into the crucible. The batch melted and after a few isolated bubbles solidified in approximately 1.5 minutes. Next 120 g of the pre-mixed batch mixture was weighed and fed into the crucible. The batch mixture melted and solidified in about 1.5 minutes. Another 120 g of the batch mixture was weighed and charged into the crucible. Again the added batch mixture melted and solidified in 1.5 minutes with no obvious foaming observed. A compact solid block of material was produced by this step.

The oven temperature was then increased to 750° C. and the batch activated further for about 30 minutes. After 30 minutes, the furnace was cooled down to ambient temperature. After cooling, the tray was weighed to obtain the net weight of the activated carbon. The total weight of carbon and tray was 2,786 g. The net weight of unwashed activated carbon was 396.8 g. By comparing with the total amount of carbon fed (560 g), the relative percent loss was estimated to be about 29 wt %.

This example had little or no foaming compared with Comparative Example 1 where significant foaming was observed in the batch. Progressive feeding of the batch allows the gases to escape without bubble formation.

### Example 3

### Demonstration of Billet Formation of by Low-Foam Progressive Feeding

### Automatic Feed

In a preliminary demonstration of principle or simulation of progressive feeding of reactants to the carbon reactor apparatus, a DC motor (⅛th horsepower) and a screw auger were used to continuously feed a dry mixture of carbon powder (5 micron particle size) and potassium hydroxide pellets at a weight ratio of 1 part carbon powder to 2 parts KOH (C:KOH=1:2 by wt.). The feed mixture material was passed through a water cooled stainless tube and dropped onto a pre-heated and static (i.e., non-rotating and non-vertically displacing) SiC plate (pre-heated to 375° C.) having a refractory dam to contain the batch mixture if it overflowed the plate. The feed rate of the batch material was set at about 7 to 9 g/min and the microwave energy source was 3 to 4 kW to supply sufficient heat to melt the mixture and react the batch materials. Total feed and heat time was approximately 50 minutes. As the powder mixture fell on the SiC plate, the powder immediately de-foamed (i.e., became stabilized with some slight bubbling or gas release but no apparent foam), and a solid billet, approximately 1.7″ high, was built up as shown in FIG. 2A. FIG. 2A shows the resulting C:KOH mound from this continuous feed experiment of about 200 g of material.

This example illustrates that a solid billet can be formed continuously by progressive feeding. Microwave (MW) power and batch feed-rate were graphed and are summarized in FIG. 2B. FIG. 2B shows time and power versus temperature data from the continuous feed experiment onto a preheated SiC plate, and having a chiller coil on the stainless steel (SS) feed tube.

### Example 4

### Activation in Slightly Oxidizing Environment

An activation process was conducted using the same process as Comparative Example 1 but in air atmosphere and without any nitrogen flow. The crucible was covered with a lid. The capacitance was measured after processing the activated material as described in Comparative Example 1. The capacitance of the activated carbon was 90 F/cc. This example illustrates that material performance can be achieved without the continuous flow of inert nitrogen gas during the activation process. The use of slightly oxidizing conditions during activation enables safe operation of the furnace since potassium vapors get oxidized immediately by reacting with the oxygen atmosphere in the furnace.

### Example 5

### Prophetic

### Continuous Billet Formation by Progressive Feeding

In accordance with the flow chart of FIG. 1, a suitable carbon feedstock (113) is combined (130) with KOH powder in weight ratio of 1:2 to form a premixture in an antechamber prior to progressive feeding of the premixture to the first chamber of the apparatus FIG. 3.

Alternatively, the carbon feedstock is continuously and progressively feed to the first chamber (310) of the apparatus of FIG. 3, for example, at about 200 grams per minute, on a vertically displacing, rotating disk conveyor (800A). Separately, simultaneously, and continuously, a weight adjusted aqueous KOH concentrated liquid (that is having a dry weight ratio of carbon:KOH=1:2) is progressively feed to the apparatus of FIG. 3 atop the continuously and previously deposited carbon layer(s) to form a billet or multi-layered admixture (e.g., having a candy cane-like structure) of carbon and KOH. Little or no forming is observed. Any incidental foam, such as may be observed with higher feed rates, is quickly dissipated by way of the thin adjacent layers of carbon and KOH and simultaneous heating at at from 300° C. to 600° C. to reduce the viscosity and foaming tendency of the mixture. Heating the billet in the second chamber's hot zone (320) at, for example, 750° C. to 900° C., chemically activates the billet. The billet is then cooled in the second zone (330), and then eroded, dispersed into a slurry, and washed (140) with water fountain wash spray (820) in the third chamber. The washed activated carbon is dried and then heat treated at 675° C. in a reducing atmosphere to afford the activated carbon product (150).

The disclosure has been described with reference to various specific embodiments and techniques. However, it should be understood that many variations and modifications are possible while remaining within the scope of the disclosure.

What is claimed is:

1. An apparatus for making an alkali activated carbon, comprising:
a first chamber for receiving, layering, and defoaming, a mixture of a carbon powder and an alkali hydroxide at from 300° C. to 600° C., to form a billet;
a second chamber comprising:
a hot zone for receiving the defoamed billet and heating the defoamed billet to from 750° C. to 900° C., to form a hot billet and to initiate carbon activation; and
a cold zone for cooling the hot billet to form a cooled billet;
a third chamber for washing the cooled billet received from the cold zone to dissolve water soluble salts and to disperse the alkali treated carbon product in the wash water; and
a conveyor that receives the carbon powder and the alkali hydroxide in the first chamber, and conveys the layered mixture into and through the second chamber, and then conveys the resulting cooled billet to the third chamber for washing.

2. The apparatus of claim 1 further comprising an antechamber situated before the first chamber to preheat the carbon powder and an alkali hydroxide, separately or in admixture, to at least 500° C. prior to delivery to the first chamber.

3. The apparatus of claim 1 wherein layering in the first chamber comprises at least one of:
depositing a layer of the mixture of the carbon powder and the alkali hydroxide;
alternately depositing a layer of the carbon powder atop a layer of the alkali hydroxide;
alternately depositing a layer of the alkali hydroxide atop a layer of the carbon powder;
or a combination thereof,
where the alkali hydroxide comprises a molten liquid, a powder, an aqueous solution, or a combination thereof.

4. The apparatus of claim 1 wherein the conveyor is a rotating disk that rotates at from 1 to 10 revolutions per minute, and the rotating disk conveys by vertical displacement at from 0.1 to 1 inch per minute.

5. The apparatus of claim 4 wherein the rotating disk conveyor includes a plurality of apertures for delivering a water spray to the billet when the rotating disk is fully conveyed to the third chamber.

6. The apparatus of claim 5 wherein the rotating disk conveyor includes a fugitive separator film or screen member that prevents the billet from fouling or plugging the apertures.

7. The apparatus of claim 1 wherein the first, second, or third chambers include a liner selected from at least one of: silicon carbide, nickel, a high-content nickel alloy, or a combination thereof.

8. The apparatus of claim 1 wherein the formed billet does not physically contact the surface of the second chamber.

9. The apparatus of claim 1 wherein the apparatus has an activated carbon throughput capacity of from about 5 to 200 kilograms per hour.

10. A method of making an alkali activated carbon in the apparatus of claim 1, comprising:
conveying the formed billet comprising a layered mixture of carbon powder and an alkali hydroxide from the first chamber to the second chamber, and simultaneously heating the conveyed layered mixture in the hot zone of the second chamber to from 750° C. to 900° C.; and
conveying the hot billet from the hot zone to the cold zone of the second chamber to form the cooled billet.

11. The method of claim 10 further comprising at least one of:
preheating the carbon powder and an alkali hydroxide to at least 500° C. prior to delivery to the first chamber;
heating the conveyed layered mixture in the hot zone of the second chamber in an oxidizing atmosphere;
or a combination thereof.

12. The method of claim 10 further comprising:
conveying the cooled billet to the third chamber to wash and erode the cooled billet, and to suspend the alkali activated carbon product in the wash; and
isolating the alkali activated carbon, comprising separating the dispersed activated carbon product from the wash water, drying the carbon product, and heating the carbon product at from 600 to 1,000° C. for 1 to 6 hours in a reducing atmosphere.

13. The method of claim 11 wherein preheating the carbon powder and the alkali hydroxide separately, and prior to delivery to the first chamber, produces a mixture free of foam when combined in the first chamber.

14. The method of claim 10 wherein the layered mixture of carbon powder and an alkali hydroxide is a dry mixture.

15. The method of claim 10 wherein the layered mixture of the carbon powder and the alkali hydroxide (MOH) has a weight ratio of carbon:MOH of from 1:1 to 1:3.

16. The method of claim 10 wherein the layered mixture of the carbon powder and the alkali hydroxide (MOH) has a weight ratio of carbon:MOH of 1:2.

17. The method of claim 10 wherein the carbon powder has a D₅₀ of 5 micrometers and the alkali hydroxide is potassium hydroxide.

18. The method of claim 10 wherein the hot billet has limited physical contact with the internal surfaces of the apparatus and corrosion of the internal surfaces of the apparatus is limited.

19. An apparatus for making alkali activated carbon, comprising:
a first chamber for combining, heating at a first temperature, defoaming, and initiating billet formation, of a mixture of a carbon powder and an alkali hydroxide;
a second chamber comprising:
a first hot zone for receiving, and heating at a second temperature higher than the first temperature, the formed billet; and
a second cold zone for cooling the billet; and
a vertically displaceable and rotating disk that receives the mixture of the carbon powder and the alkali hydroxide in the first chamber and conveys the received mixture to and through the second chamber.

20. The apparatus of claim 19 further comprising:
a third chamber adjacent the second chamber, the third chamber irrigates the billet conveyed from the second cold zone, to form a washed and suspended dispersion of the activated carbon.
